(19) United States
(12) Patent Application Publication
(10) Pub. No.: US 2017/0340000 A1
(43) Pub. Date: Nov. 30, 2017

(54) DRINK CONTAINER DELIVERY SYSTEM

(71) Applicant: William Willard, Johnstown, NY (US)

(72) Inventor: William Willard, Johnstown, NY (US)

(21) Appl. No.: 15/598,058

(22) Filed: May 17, 2017

Related U.S. Application Data
(60) Provisional application No. 62/343,558, filed on May 31, 2016.

(51) Int. Cl. A23P 30/10

(52) U.S. Cl. CPC A23P 30/10

(57) ABSTRACT

Disclosed is a drink container delivery system, including methods of formation and use. The drink container delivery system provides a biodegradable and compostable drink container, ideal for small volume “energy shots” and other liquid compositions. The system is also used with granular solid and gel compositions. In addition to acting as a packaging vessel for the composition, micro droplets of the composition are dispersed throughout the substance of the container and are released by mechanical disruption, such as by chewing. The container is formed from wax or similar non-toxic material and can be safely chewed and eventually discarded responsibly by the user wherein the container material biodegrades naturally.

### BACKGROUND OF THE INVENTION

### Technical Field

This invention relates to biodegradable containers and delivery systems for compositions made for human consumption. Specifically, the invention relates to sealed wax containers filled with energy drink compositions.

### State of the Art

A variety of substances, including vitamins and related nutritional supplements, medications, naturopathic remedies, and the like are consumed by persons to address many conditions. Examples of such conditions include pain, heartburn, minor viral upper respiratory infections such as the common cold, and hangovers. In many cases, these substances are delivered to the user in the form of a “drinkable shot.” Similarly, energy drinks are used by persons involved in many activities and often taken in shot form. Recreational and professional athletes, college students and late-night office workers, outdoor enthusiasts, hikers, and many others consume energy drinks every day to keep alert and increase physical performance under stress. Energy drinks are packaged in cans and bottles. Canned energy drinks are stored and consumed like any typical canned soda or other beverage. Cans, however, are bulky and therefore inconvenient to carry while participating in athletic activities, backpacking, and the like. Accordingly, energy drink “micro shots” are a subset of energy drinks with ingredients concentrated into a smaller volume of solution; generally less than 2.5 ounces per serving. Smaller “shots” of about one ounce are used by runners, cyclists, and endurance athletes.

There is a large market for drinkable shots, particularly medicinal, homeopathic, and energy micro shots, with weekly sales of over ten million bottles worldwide per week. This figure does not account for other non-degradable packaging options, such as thickened-foil pouches and the like, used to hold the smaller shots used by athletes during endurance training and competition. Many millions of small plastic bottles, pouches, and additional packaging material, therefore, are discarded each week, eventually to end up in landfills. Although sometimes recyclable, these bottles and pouches are not biodegradable or compostable.

Moreover, packaging of micro shots merely acts as a vessel for the composition until ready for consumption by the user. The packaging does not directly contribute to achieving a desired effect from the composition—the longest feasible duration of alertness and energy—for the user.

Accordingly, what is needed is container for a drinkable shot composition which is biodegradable and contributes to delivery of the composition to a user.

### DISCLOSURE OF EMBODIMENTS OF THE INVENTION

Embodiments of the present invention include a drink container delivery system, methods of forming a container that additionally functions as a delivery system for liquid or solid compositions for human consumption, and methods of packaging and using the delivery system, which include releasing the composition from the material comprising the container. The foregoing and other features and advantages of the invention will be apparent to those of ordinary skill in the art from the following more particular description of the invention and the accompanying drawings.

Disclosed is a drink container delivery system comprising a wax; a composition; and a container bounding a space, wherein the container comprises a solidified mixture of the wax and the composition.

In some embodiments, the space is occupied by the composition. In some embodiments, the container further comprises a seal, wherein the seal restricts the composition in the space.

In some embodiments, the mixture comprises a suspension of liquid micro droplets of the composition distributed within the wax. In some embodiments, the mixture comprises solid particles of the composition distributed within the wax. In some embodiments, the delivery system further comprises a wax coating coupled to an outer surface of the container.

In some embodiments, the micro droplets are less than about 50 microns in size. In some embodiments, the micro droplets are between about 50 microns and about 100 microns in size. In some embodiments, the micro droplets are between about 100 microns and about 250 microns in size. In some embodiments, the micro droplets are between about 250 and about 500 microns in size. In some embodiments, the micro droplets are between about 500 microns and about 750 microns in size, In some embodiments, the micro droplets are between about 750 microns and about 1000 microns in size. In some embodiments, the micro droplets are larger than about 1000 microns in size.

In some embodiments, the container holds a first concentration of the composition; and the mixture comprises a second concentration of the composition, wherein the second concentration is greater than the first concentration. In some embodiments, the second concentration is less than about five times greater than the first concentration. In some embodiments, the second concentration is between about five times and about ten times the first concentration. In some embodiments, the second concentration is between about ten times and about one hundred times the first concentration. In some embodiments, the second concentration is greater than about one hundred times the first concentration.

Disclosed is a method of forming a drink container delivery system comprising the steps of providing a drink composition; providing a wax composition; melting the wax composition; and mixing the drink composition with the wax composition to form a suspension of liquid micro droplets within the wax composition.

In some embodiments, the method further comprises a step of molding the mixed composition into a shape of a container. In some embodiments, the method further comprises a step of filling the container with the drink composition. In some embodiments, the method comprises a step of sealing the container to contain the liquid composition. In some embodiments, the method comprises a step of chewing the container to disrupt the liquid micro droplets causing release of the drink composition from the liquid micro droplets.

### BRIEF DESCRIPTION OF THE DRAWINGS

FIG. 1 is a perspective view of a drink container delivery system;

FIG. 2 is an exploded view of a portion “A” of a container of a drink container delivery system;

FIG. 3 is a flowchart showing steps of a method 200 for forming a dink container delivery system; and

FIG. 4 is a flowchart showing steps of additional embodiments of method 200 for forming a drink packaged in a drink container delivery system; and

FIG. 5 is a flowchart showing steps of a method 300 of forming a drink container delivery system to cause extended release of a composition for consumption by a user.

### DETAILED DESCRIPTION OF EMBODIMENTS OF THE INVENTION

Embodiments of the present invention relate to a drink container delivery system. In particular, the invention relates to a container for holding liquids, gels, or solids for human consumption, methods of forming a container which additionally functions as a delivery system for liquid, gel, or solid compositions for human consumption, and methods of packaging and using the delivery system, including releasing the composition from the mixed material composition of the container.

There is a product category of drinkable shots that is addressing pain, heartburn, provision of homeopathic remedies for a variety of minor, common conditions such as the common cold, hangovers, and the like. Some of these compounds are provided for buccal absorption, such as lozenges to be place under the tongue or atomized sprays to be applied to the mouth and oropharynx. Others are formulated for less rapid enteric absorption in the stomach and small intestine.

A separate product category of concentrated drinkable shots comprises energy drinks. Athletes, whether recreational or professional, consume energy drinks and gels during activities, particularly extended-duration activities. There are many commercially available drinks and gels which provide concentrated glucose, caffeine and other stimulants, and additional ingredients which support physical performance, stamina, alertness, and mindfulness. These compositions are often provided in reduced-volume concentrated formulations which are conveniently packaged to take up a very limited amount of space, such as in small plastic bottles or foil pouches which the user can conveniently carry on his or her person, even while actively engaging in an athletic activity. Although convenient, these existing packaging solutions are generally not environmentally friendly, being neither biodegradable nor compostable. Additionally, existing formulations are provided for oro-buccal or enteric absorption, but not both. Further, existing packaging solutions serve as containers, but do nothing to enhance the efficacy of the packaged composition.

Embodiments of the instant invention resolve these and other deficiencies by providing an easy-to-use portable container made from a biodegradable/compostable material, wherein the material forming the container also acts as a delivery system for the composition packaged inside. Specifically, in some examples, the container is formed by a non-toxic wax comprising micro droplets of the composition. To form the container, the wax is melted and then mixed with the a medicinal compound, homeopathic remedy, energy drink, or alternative composition to be packaged inside the finished container utilizing a process which creates an even dispersion of micro droplets of a composition distributed throughout the wax. The melted wax-composition mixture is then molded into a container utilizing conventional methods known in the art of food packaging. The container may be filled with an additional quantity of the composition and sealed, such as by annealing or similar use of heat or pressure to fuse the wax or a similar substance forming the container. A quantity of the filled and sealed containers are then boxed or otherwise packaged in larger conventional containers for distribution and sale. Notably, in some embodiments of the invention, the concentration of the composition forming the micro droplets is substantially higher than the concentration of composition contained within the container vessel, wherein chewing and otherwise retaining the packaging container in the oral cavity disrupts micro droplets releasing small quantities of highly concentrated composition over an extended time period for rapid oro-buccal absorption.

Filled containers, which may be in the general shape of a pouch or bottle, are carried in some convenient fashion by the user, depending on whether the user is engaged in studying, working, or an athletic activity, according to the particular athletic activity and the intended purpose for the composition inside. The user may open the container by a mechanical action, such as tearing or biting through the container, depending upon the particular shape and configuration of the container and the user's preference. The user may then consume the composition packaged inside. Additional composition, however, is contained within the substance of the container itself, as described briefly above. Following consumption of the packaged composition, the user may replace the empty small, portable container in a pocket, other clothing pouch, back-pack, purse, etc. for later retrieval and consumption of additional composition suspended within the material of the container. Alternatively, the user may choose to immediately chew the material of the container, wherein additional composition is released and ingested.

After the user has completed his or her extraction of all the composition desired from the container package and the material composition of the container, the user has multiple environmentally friendly options for disposal of the material which remains following chewing of the container. For example, if the user chooses to throw the container in a trash receptacle, the wax material comprising the container will biodegrade in a landfill, albeit slowly. Alternatively, the user may choose to place the empty container in a composting container, wherein aliphatic hydrocarbon chains comprising the wax are more rapidly degraded, facilitated by heat and enzymatic action of the composting bacteria present in the compost mix.

Finally, and perhaps most desirably, the user may elect to chew the wax itself similar to chewing gum. Chewing of the wax is effective to achieve at least two desirable results: 1) continued release of composition to the user; and 2) user relaxation through chewing the substance of the container.

First, chewing of the container actuates the extended delivery mechanism of the drink container delivery system. Chewing the container fragments the wax or other material wherein suspended micro droplets or particles of composition dispersed throughout the material are disrupted, delivering the maximum quantity of available composition to the user over an extended time period. Chewing the wax-composition mixture comprises a mechanism wherein a continuous additional quantity of composition is released from the wax-composition mixture in a timed-release fashion, substantially prolonging the duration wherein active ingredients of the composition provide the composition's desirable physiological effects to the user. Further, in some embodiments of the invention, the composition forming the micro droplets comprises a substantially higher concentration than the concentration of the much larger volume “bolus dose” of composition packaged within the container. The user, therefore, immediately receives a large volume of low-concentration composition, such as an energy-drink composition, upon opening the sealed container. Swallowing this larger volume provides the user with an initial dose of glucose, caffeine, and other energy-producing components of the composition to rapidly establish an effect from the composition's active ingredients. After the user consumes this initial dose, upon chewing the container material, the user receives an additional steady, incremental dosing of composition from the disrupted micro droplets of composition dispersed throughout the wax material. In embodiments wherein the micro droplets are relatively small, upon chewing of the container wax over a relatively extended time, mastication disrupts additional micro droplets or solid particles, releasing a slow and essentially continuous quantity of composition. In this manner, the user continues to slowly ingest additional quantities of the composition over time, providing extended steady-state delivery of the composition to the user.

Second, chewing the substance of the container is inherently relaxing, similar to chewing gum or using smokeless tobacco.

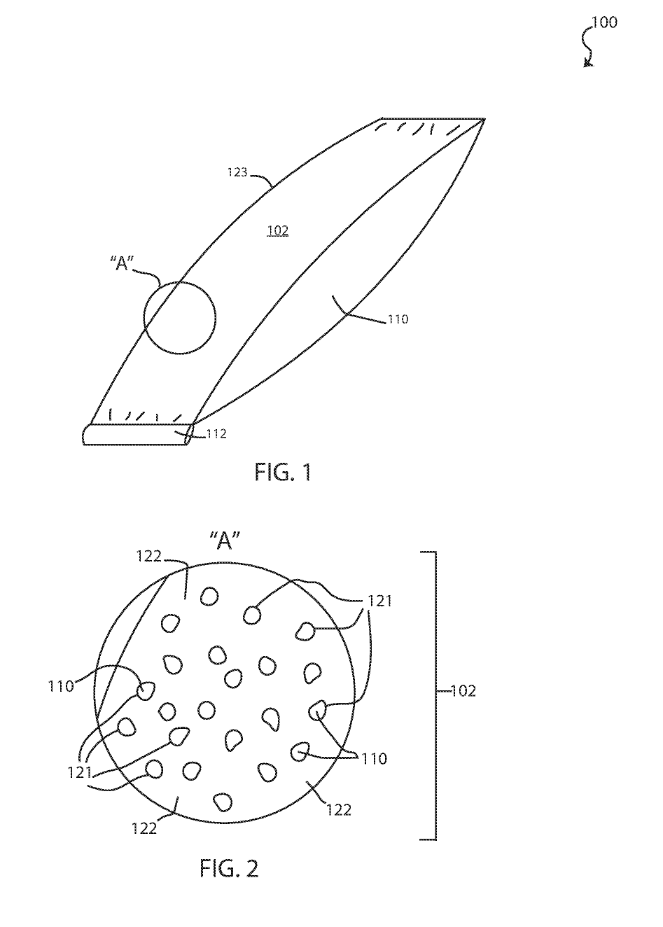

FIG. 1 is a perspective view of a drink container delivery system 100. FIG. 1 shows a container 102 filled with a composition 110 and comprising a seal 112. In the example embodiment shown, and some other embodiments, container 102 is formed in the general shape of an elongated pouch with two ends, filled with a composition 110 and sealed at one of the two ends by a seal 112. The pouch shape shown in FIG. 1 is not meant to be limiting. In some embodiments, container 102 may be formed in other shapes and need not have two ends. For example, container 102 may be formed into a generally spherical shape, into a rectangular or other angled or polygonal shape, into the shape of a cartoon character, into an alternative whimsical shape, or into any shape desired by the manufacturer, without limitation. Some examples of factors which may influence the choice of shape include the intended purpose of the composition, demographics of the intended consumer group (such as age, gender, and cultural background, for example), and other factors, in some embodiments.

In the example embodiments shown in FIG. 1, container 102 is filled with composition 110. In some embodiments, composition 110 is an energy drink. For the disclosures provided herein, an “energy drink” means a beverage that typically contains caffeine or similar stimulant and other ingredients, such as taurine, ginseng, or the like, intended to increase the user's perceived energy level. Energy drinks are widely consumed by athletes, night-shift workers, campers and backpackers, students, and the like. Accordingly, energy drinks represent an excellent example of incorporating composition 110 into delivery system 100, including incorporation into micro droplets comprising the material forming container 102, as discussed in further detail below. Energy drinks are packaged as a portable comestible for consumption by persons “on the go” in situations wherein both the availability of a continuous-release delivery system over an extended time period and readily available disposal options for packaging are desirable. For these and other reasons, packaging of energy drinks in a container which can ultimately be chewed like gum is desirable. After chewing, the remnants of the container may be responsibly discarded into a trash receptacle. Moreover, the container remnants naturally decompose following collection and placement in a landfill or other waste disposal location. This example is not meant to be limiting, however. Container 102 is used to package composition 110 comprising any number of compounds, such as medications, nutrients, flavorings, and the like. Composition 110, in some embodiments, is a liquid composition. In some embodiments, composition 110 is a solid composition, such as a powder, granules, beads, and the like. In some embodiments, composition 110 is a gel, such as a concentrated carbohydrate energy gel, for example.

Seal 112 functions to close container 102 after filling container 102 with composition 110. In some embodiments, such as the example embodiments shown in FIG. 1, seal 112 is a generally linear structure formed after approximating two edges of an opening, such as the opening wherein container 102 is filled with composition 110, and applying heat, applying pressure, or applying heat and pressure to fuse the wax or other suitable composition forming container 100. In some embodiments, seal 112 is curvilinear. In some embodiments, an alternative filling technique, such as twin-port injection with simultaneous venting, is employed to fill container 102 with composition 110. Accordingly, in such and some other embodiments wherein a means of closure of container 102 after filling with composition 110 is not necessary, seal 112 may be absent.

In some embodiments, drink container delivery system 100 further comprises a coating 123, as shown in FIG. 1. Coating 123, in some embodiment, is coupled to an outer surface of container 102 and functions to cover and protect micro droplets of composition 110 dispersed and suspended within the material composition of container 102 at or near the outer surface of container 102. In some embodiments, coating 123 is formed from a wax material, which may be the same wax used to form container 102 or which may be a different wax than the wax used to form container 102. In some embodiments, coating 123 is an alternative substance, such as a polysaccharide, polyvinyl acetate phthalate, cellulose acetates, alginates, or similar non-toxic coating material. Coating 123 forms a barrier to protect micro droplets of composition 110 near the outer surface of container 102 from mechanical disruption which might result from routine handling of container 102. Coating 123, in some embodiments, shares important properties of the material forming container 102, such as biodegradability, ability to compost, and non-toxic composition.

FIG. 1 additionally shows an area “A” comprising a portion of container 102 of drink container delivery system 100. Area A is shown in detail by FIG. 2, which is an exploded view of area “A” of a container of drink container delivery system 100. The exploded detail shown by FIG. 2 demonstrates a plurality of micro droplets 121 suspended and dispersed throughout a wax 122. In some embodiments, wax 122 comprises a non-toxic chemical wax, meaning a natural or synthetic oily or greasy heat-sensitive substance which is solid or plastic at room temperature, comprising esters of fatty acids and aliphatic hydrocarbons which is insoluble in water or aqueous solutions. The use of wax to form wax 122 is not meant to be limiting. In some embodiments, other non-toxic substances which are soft, may be chewed, are biodegradable under some environmental conditions, will compost, which may be molded into a container, and which may be melted at relatively low temperatures so as to facilitate suspension and dispersion of micro droplets 121 throughout the substance of wax 122 may be used. Micro droplet 121 is a single pocket of composition 110 suspended within the substance of wax 122. During manufacture of container 102, wax 122 is heated and consequently converts to a liquid phase. Composition 110 is then atomized and dispersed throughout molten wax 122 using standard commercial processes known in the art. As used herein, “atomize” means to convert a substance into very fine particles or droplets. Micro droplets 110 are generally evenly distributed throughout wax 122. Wax 122 and suspended composition 110 dispersed as micro droplets 121 is than allowed to harden and stored as a solid, prior to re-melting and molding into container 102, in some embodiments. In some embodiments, molten wax 122 comprising suspended micro droplets 121 is immediately molded into containers 102, prior to hardening.

As mentioned briefly herein above, in some embodiments, the concentration of active ingredients comprising composition 110 packaged in container 102 and the concentration of active ingredients comprising composition 110 forming micro droplets 121 is about the same. In some embodiments, however, composition 110 packaged in container 102 comprises a first concentration and composition 110 forming micro droplets 121 comprises a second concentration. In some embodiments of drink container delivery system 100 comprising first concentration and second concentration, the second concentration is substantially greater than the first concentration. In this manner, the greater second concentration allows for correspondingly much smaller volumes of composition 110, such as a microliter-scale volume comprising a micro droplet, to deliver a larger quantity of active ingredient to the user upon mechanical disruption of micro droplet 121, such as by chewing wax 122. A user who has initially consumed a quantity of first concentration composition 110 packaged in container 102 may experience delivery of a relatively steady quantity of an active ingredient comprising composition 110 by simply chewing container 102 over an extended period of time. As container 102 is chewed, a relatively small number of micro droplets 121 are mechanically disrupted, releasing small volumes of second concentration composition 110 during mastication for slow, continual delivery of composition 110 to the user. The continual consumption of microliter-volume quantities of highly concentrated composition 110 sustains the desired effect of composition 110 on the user for an extended time period. When the user no longer desires to continue consumption of composition 110, the user may spit-out and discard the remaining portion of wax 122 comprising container 102.

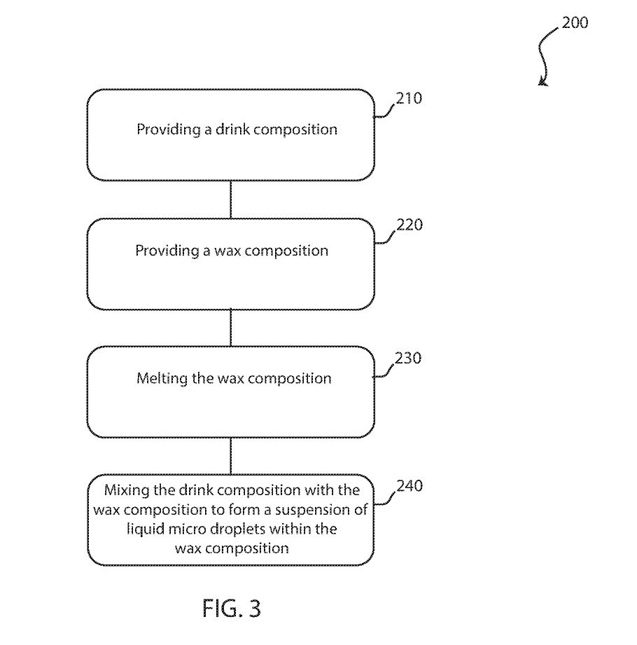

FIG. 3 is a flowchart showing steps of a method 200 for forming a drink container delivery system. FIG. 3 shows method 200 comprising a first providing step 210, second providing step 220, a melting step 230, and a mixing step 240.

First providing step 210 comprises providing a drink composition. In some embodiments, the drink composition comprises an energy drink. This is not meant to be limiting. Other drink compositions may comprise medications, flavorings, nutritional supplements, and the like, without limitation. In some embodiments the “drink” composition is a liquid, a gel, a solid particulate or a mixture of solid and liquid materials. Second providing step 220 comprises providing a wax composition. The wax composition may be a chemical or a natural wax, as mentioned herein. Alternatively, the “wax” composition may comprise any non-toxic, solid material which forms a cohesive food bolus upon chewing. Melting step 230 comprises melting the wax composition. Melting step 230 is performed, in some embodiments, by use of a heating means and melting technique known in the art. Mixing step 240 follows melting step 230 and comprises mixing the drink composition with the wax composition to form a suspension of liquid micro droplets within the wax composition. Mixing step 240 is performed, in some embodiments, by atomizing the drink composition followed by mixing the atomized drink composition with the melted wax composition. In some embodiments, mixing step 240 further comprises hardening the liquid mixture into a formed shape.

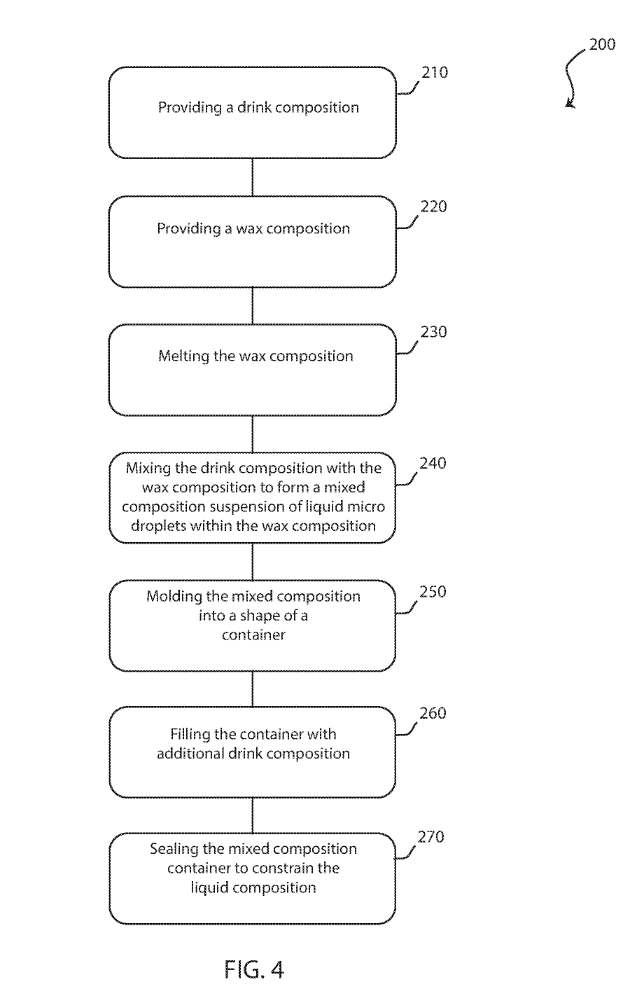

FIG. 4 is a flowchart showing steps of an alternative embodiment of method 200 for forming a drink container delivery system. As shown in FIG. 4, some embodiments of method 200 additionally comprise a molding step 250. Molding step 250 comprises molding the mixed composition into a shape of a container. In some embodiments, the formed shape is the shape of a container suitable for packaging the drink composition. “Shape of a container” means a container shaped for packaging a liquid, gel, or particulate solid composition, without limitation, as discussed herein above.

In some embodiments, method 200 additionally comprises a filling step 260. As shown in FIG. 4, filling step 260 comprises filling the container with additional drink composition. Filling step 260 is performed, in some embodiments, by an automated filling means. In some embodiments, method 200 additionally comprises a sealing step 270. Sealing step 270 comprises sealing the container to constrain the liquid composition. In some embodiments, sealing step 270 if performed by approximating two edges of an opening in the container and applying heat to the mixed composition comprising the container. In some embodiments, sealing step 270 comprises applying pressure to the two approximated edges of the opening in the container. In some embodiments, sealing step 270 comprises performing another commercially available process to the approximated edges of the opening in the container to fuse the edges, thus, causing the opening to be eliminated and constraining the contents within the container.

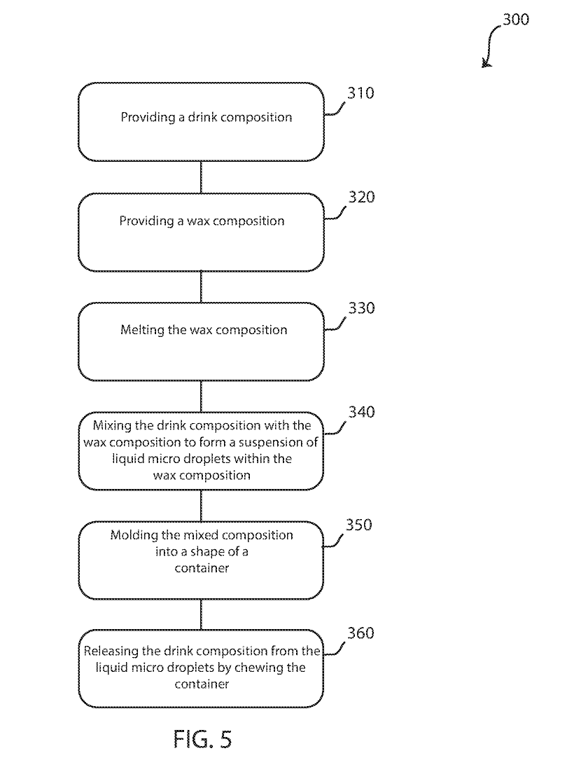

FIG. 5 is a flowchart showing steps of a method 300 of using a drink container delivery system. Method 300 comprises a third providing step 310, a fourth providing step 320, a second melting step 330, a second mixing step 340; a second molding step 350; and a chewing step 360. Third providing step 310, fourth providing step 320, second melting step 330, third mixing step 340, and molding step 350 comprise the same method steps as first providing step 210, second providing step 220, melting step 230, mixing step 240, and molding step 250 respectively. Releasing step 360, in some embodiments of method 300, comprises releasing the drink composition from the liquid micro droplets by chewing the container. As the user of the drink container delivery system chews the container, additional quantities of the composition are released as chewing mechanically disrupts a quantity of the wax wherein the micro droplets are released, creating sustained availability of the composition to the user chewing the container over an extended time period. In some embodiments, the user swallows solid particles of the mixed composition which remain after disrupting the container during chewing step 360. In some embodiments, the user spits out and properly discards the remaining mixed composition after chewing the container.

An example of the use of a drink container delivery system is provided. This non-limiting, illustrative example of the use of a drink container delivery system represents some embodiments, and involves an athlete, for the purposes of this example, a baseball pitcher. Baseball pitchers sometimes use chewing tobacco and other tobacco products to provide sustained release of nicotine, which is an energy-producing compound. Chewing a tobacco product while pitching in a baseball game is a calming and relaxing activity for baseball pitchers, who must concentrate and manage stress in complicated situations which arise during baseball pitching. Energy drinks and related compositions are, arguably, healthier than tobacco products. Tobacco leaves, however, provide a very effective continual sustained-release delivery system for nicotine and other compounds present in tobacco which increase alertness, concentration, and possibly athletic performance. The baseball pitcher, therefore, selects an energy drink from a variety of energy drinks provided in drink container delivery system 100. Because composition 110 is relatively concentrated and sealed within container 102, container 102 is small and fits easily into a pocket of the pitcher's baseball uniform. Container 102 may, possibly, have been formed in a generally flat, rectangular shape to facilitate fitting into the pocket of a uniform or similar garment. Shortly before the game begins, the pitcher removes the container from his pocket and bites off and swallows a small corner of the non-toxic wax container, not needing to either discard the corner on the ground or search for a suitable trash receptacle. The pitcher may perform this act while standing on the pitching mound during a game, before a grandstand filled with baseball fans. The pitcher then ingests composition 110 from container 102, wherein the pitcher subsequently receives the desired active ingredients from the ingested bolus of composition 110. The pitcher then places container 102, now empty, back into his pocket, and begins to pitch to the first batter. At some future time—perhaps a short time later while pitching, perhaps while sitting in the dugout in between innings, or some other point later in the game—the pitcher is feeling stressed and wants to further increase his alertness and concentration while calming his nerves. The pitcher thus removes container 102 from his pocket and bites off a portion, replacing the remainder in his pocket. The pitcher chews the portion for an extended period. As the pitcher chews, micro droplets 121 are disrupted and additional composition 110 is released into the pitcher's mouth, which he swallows, occasionally along with small particles of container 102. As the pitcher slowly receives additional composition 110, his alertness and concentration increase and remain increased over an extended time period as he continues to chew container 102. Moreover, the act of chewing the wax material comprising container 102 calms the pitcher, much like chewing a bolus of chewing tobacco or gum. Eventually, perhaps hours later at the end of the game, the pitcher has chewed the remains of container 102, slowly extracting additional composition 110 from the wax-micro droplet mixture. The pitcher has also enjoyed the calming effect of chewing the wax material.

A drink container delivery system, methods of formation, and methods of use have been described. The container is packaging for a drink, a granular solid, a gel, or a mixed solid-liquid composition and also serves as an extended-release delivery system for the composition. The container is biodegradable and compostable. Additionally, methods of formation and use are described, wherein sustained delivery of an extended supply of the composition provides active ingredients over time, continuing effects of the composition for the user. The disclosed methods of formation and use allow for the effective, safe, and convenient use of a drink container delivery system by the end-user.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A drink container comprising:
a wax;
a composition; and
a container bounding a space, wherein the container comprises a solidified mixture of the wax and the composition.

2. The container of claim 1, wherein the space is occupied by the composition.

3. The container of claim 2, wherein the container further comprises a seal restricting the composition in the space.

4. The container of claim 1, further comprising a wax coating coupled to an outer surface of the container.

5. The container of claim 1, wherein the mixture comprises solid particles of the composition distributed within the wax.

6. The container of claim 1, wherein the mixture comprises a suspension of liquid micro droplets of the composition distributed within the wax.

7. The container of claim 6, wherein the micro droplets are less than about 50 microns in size.

8. The container of claim 6, wherein the micro droplets are between about 50 microns and about 250 microns in size.

9. The container of claim 6, wherein the micro droplets are between about 250 and about 1000 microns in size.

10. The container of claim 6, wherein the micro droplets are larger than about 1000 microns in size.

11. The container of claim 2, wherein the space is occupied by a first concentration of the composition and the mixture comprises a second concentration of the composition, wherein the second concentration is greater than the first concentration.

12. The container of claim 11, wherein the second concentration is less than about five (5) times greater than the first concentration.

13. The container of claim 11, wherein the second concentration is between about five (5) times and about ten (10) times the first concentration.

14. The container of claim 11, wherein the second concentration is greater than about ten (10) times the first concentration.

15. A method of forming a drink container delivery system comprising the steps:
providing a drink composition;
providing a wax composition;
melting the wax composition; and
mixing the drink composition with the wax composition to form a suspension of liquid micro droplets within the wax composition.

16. The method of claim 15, further comprising a step molding the mixed composition into a shape of a container.

17. The method of claim 15, further comprising a step filling the container with the drink composition.

18. The method of claim 15, further comprising a step sealing the container to contain the liquid composition.

19. The method of claim 15, further comprising a step chewing the container to disrupt the liquid micro droplets causing release of the drink composition from the liquid micro droplets.

20. A method of forming a drink container delivery system to cause extended release of a composition for consumption by a user comprising the steps:
providing a drink composition;
providing a wax composition;
melting the wax composition;
mixing the drink composition with the wax composition to form a suspension of liquid micro droplets within the wax composition;
molding the mixed composition into a shape of a container; and
releasing the drink composition from the liquid micro droplets by chewing the container.
